(19) United States
(12) Patent Application Publication
(10) Pub. No.: US 2024/0023756 A1
(43) Pub. Date: Jan. 25, 2024

(54) Electric Grill

(71) Applicant: Active Food Systems Limited, St. Neots, Cambridgeshire (GB)

(72) Inventors: George Justin Peter Cadbury, St. Neots, Cambridgeshire (GB); Andrew Norman Edwards, St. Neots, Cambridgeshire (GB); Sam O'Rourke, St. Neots, Cambridgeshire (GB)

(73) Assignee: Active Food Systems Limited, St. Neots, Cambridgeshire (GB)

(21) Appl. No.: 18/033,015

(22) PCT Filed: Oct. 27, 2021
(86) PCT No.: PCT/EP2021/079836

§ 371 Date: Apr. 20, 2023

(30) Foreign Application Priority Data
Oct. 29, 2020 (DE) 2017147.6
Mar. 17, 2021 (DE) 2103717.1

(51) Int. Cl. A47J 37/07; H05B 3/68

(52) U.S. Cl. CPC A47J 37/0754; A47J 37/0709; H05B 3/68

(57) ABSTRACT

An electric grill comprises a heating platform, side walls, and grill bars spaced above the heating platform, together defining a heating chamber. The heating platform is heated electrically. A first air supply delivers pressurised air evenly across the heating platform from a central location. A second air supply directs airflow along the side walls to create a vortex of air flowing around the first air supply. The forced airflow provides for fuller combustion of fats and oils from foodstuffs being cooked so that no fat tray is required.

The present invention relates to an electric grill, also known as a chargrill, in which food is cooked while resting on heated grill bars.

Typical commercial electric chargrills utilise electric heating elements housed within the grill bars on which food items rest. Fats and oils generated by the cooking process are channelled away into a fat tray, which may also contain water to reduce the risk of fat fires. Over time, the fat tray will become full of fatty residue and this must be safely disposed of. However, fat fires are still a major concern and there are widespread problems with inappropriate disposal of fatty residues such as disposal down drains.

The present invention provides an electric grill comprising a heating platform, a plurality of side walls, a plurality of grill bars spaced above the heating platform and a heating chamber defined between the heating platform, the side walls and the grill bars, wherein the heating platform is electrically heated, the grill further comprising a first air supply located centrally in the heating platform for delivery of pressurised air into the heating chamber and configured to direct airflow out across the heating platform, and a secondary air supply located in the side walls and configured to direct airflow along the side walls to create a vortex of air flowing around the centrally located first air supply.

Preferably, the heating platform comprises two conductive plates with electric heating elements sandwiched in between them. For example, the first plate may comprise upper and lower surfaces and a plurality of grooves are formed on the lower surface, the second plate may comprise upper and lower surfaces and a plurality of grooves are formed in the upper surface, wherein the grooves in the first and second plates co-operate to form channels for receiving heating elements when the first and second plates are sandwiched together.

The grill bars do not contain heating elements and are heated by radiation from the heating platform. Preferably the heating platform is configured to reach a temperature of up to 500° C. so as to heat the grill bars to a temperature up to 350° C. For example, the heating platform may be formed from metal or a ceramic material.

The first air supply may comprise at least one opening in the heating platform connected to a source of pressurised air and an airflow diverter configured to divert airflow evenly across the surface of the heating platform. The airflow diverter may comprise an elongate column extending through an opening in the heating platform and a cap mounted on the upper end of the column. In particular the airflow diverter may comprise a column with a plurality of radially projecting ribs.

The second air supply may comprise at least one opening in each side wall located adjacent an end of the side wall and connected to a source of pressurised air.

Preferably, the heating platform and side walls are located within a housing having inner and outer walls and an air chamber between the inner and outer walls, wherein the air chamber is connected to a source of pressurised air and communicates with the opening in the heating platform and with the openings in the side walls. Typically, the source of pressurised air comprises at least one fan.

In another embodiment, the heating platform and side walls are located within a housing having inner and outer walls and a first air chamber between the inner and outer walls, wherein the air chamber is connected to a source of pressurised air and communicates with the openings in the side walls of the heating chamber, and further comprising a second air chamber defined between the heating platform and the inner wall of the housing, wherein the source of pressurised air comprises a fan configured to draw air from the second air chamber and to supply it to the first air chamber.

The present invention will now be described, by way of example only, with reference to the accompanying drawings in which:

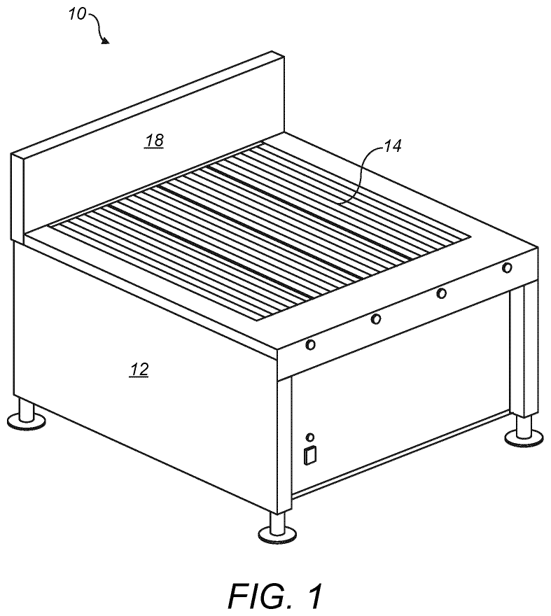

FIG. 1 is a perspective view of an electric grill in accordance with one embodiment of the present invention;

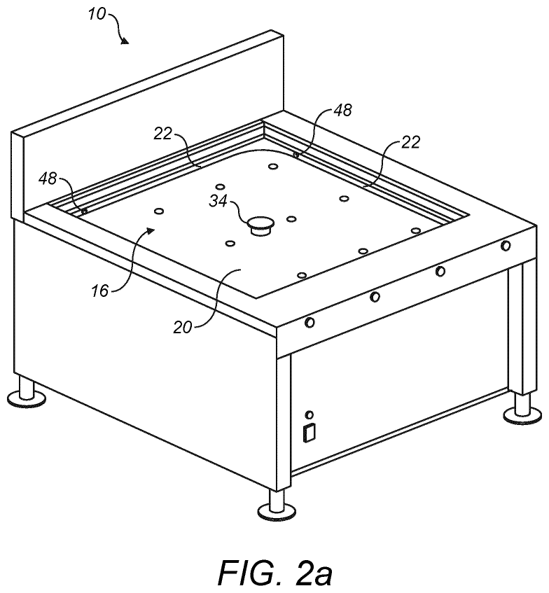

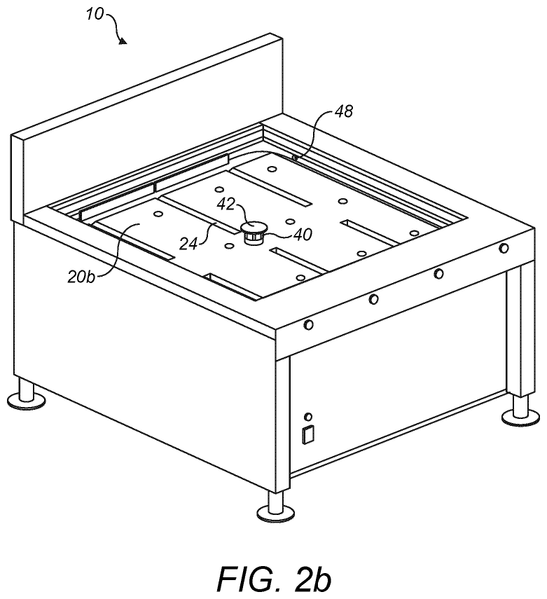

FIG. 2a shows the grill of FIG. 1 with the grill bars removed to show the heating chamber and heating platform beneath;

FIG. 2b is similar to FIG. 2a but shows the upper plate of the heating platform also removed;

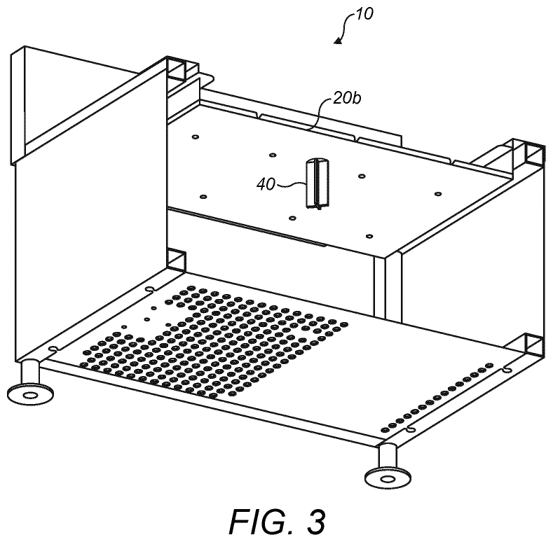

FIG. 3 is a perspective cross sectional view of the grill of FIG. 1 from below, with some parts removed to show the underside of the heating platform;

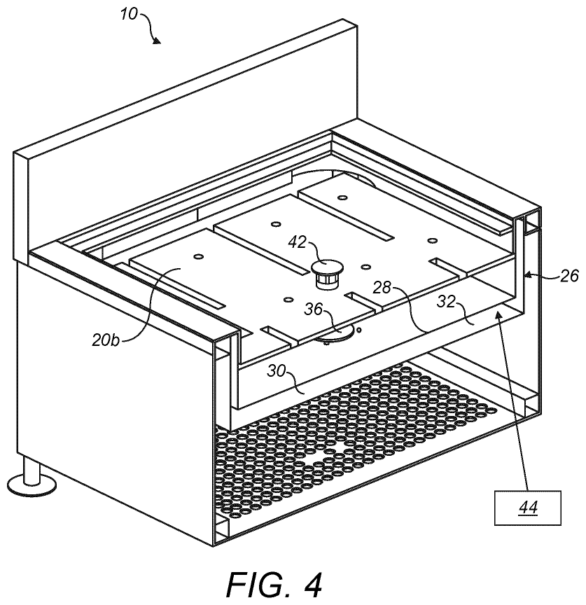

FIG. 4 is a perspective cross sectional view of the device of FIG. 2b from above, showing the air chamber;

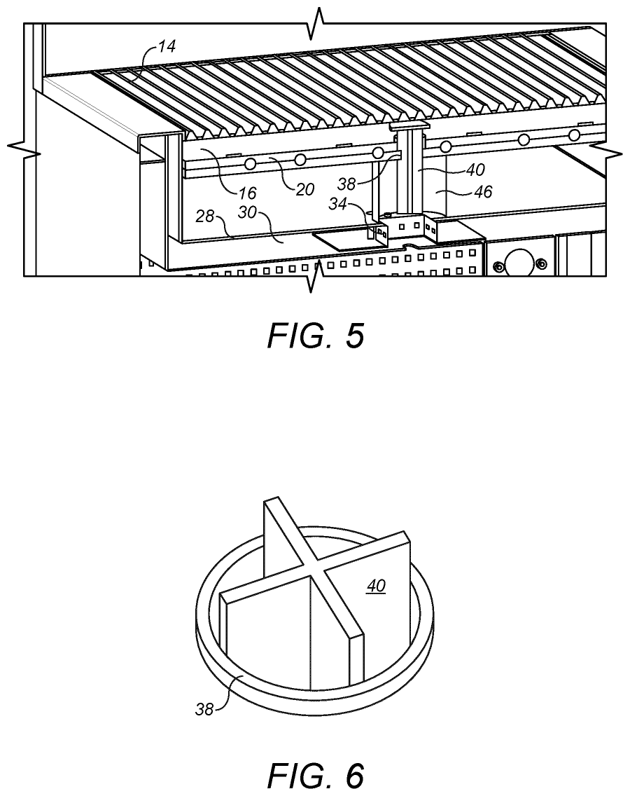

FIG. 5 shows a cross-section of the air channelling device;

FIG. 6 is a view of the top of the air channelling device with the upper cap removed;

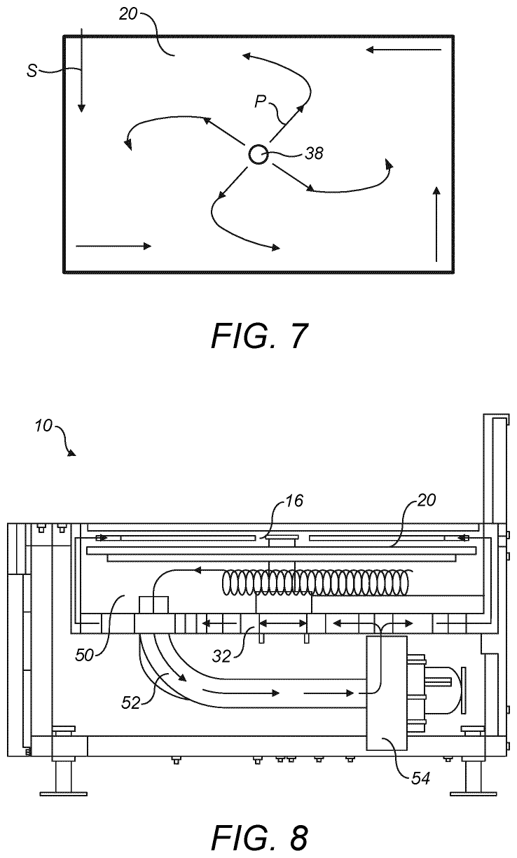

FIG. 7 is a schematic plan view of the heating platform illustrating the airflow;

FIG. 8 is a side view, partly in section, of a second embodiment of the present invention.

FIG. 1 shows a perspective view of an electric grill 10 in accordance with one embodiment of the present invention. This is illustrated as a freestanding unit, but a grill incorporating the present invention could also be configured as a built-in unit.

The grill 10 comprises a body 12 largely made of sheet metal. Grill bars 14 are provided above a heating chamber which is subscribed further below. The body 12 may include a vertical back plate 18. Although not shown, a hinged lid may also be provided which can close over the top of the grill bars 14 to provide an enclosed cooking chamber. The grill bars 14 are typically made of cast iron and are able to withstand temperatures up to about 250-350° C.

FIGS. 2a and 2b show part of the grill 10 in FIG. 1 with the grill bars 14 removed to show the heating chamber 16 beneath. The heating chamber 16 is defined between a heating platform 20, side walls 22 and the grill bars 14 (when present).

The heating platform 20 is electrically heated. Electrically powered heating elements may be located within the heating platform 20. For example, the heating platform may comprise two metal plates 20a,20b each with upper and lower surfaces. The lower surface of the upper plate 20a and the upper surface of the lower plate 20b are both machined with a number of grooves 24. When the plates 20a and 20b are sandwiched together the grooves 24 in each plate align to define channels into which heating elements are fitted. For example, the grooves 24 may be semi-circular in cross-section so that when the plates 20a and 20b are sandwiched together, the grooves 24 align to define channels with a circular cross-section. FIG. 2a shows the upper plate 20a in place and FIG. 2b shows the lower plate 20b with the grooves 24, the upper plate 20a having been removed for illustrative purposes.

As noted above, the two plates 20a, 20b may both be formed of metal, e.g. steel, or another conductive material, for example a ceramic material such as silicon carbide. In this case, heat insulation may be provided underneath the heating platform 20. Alternatively, the lower plate 20b may itself be formed from an insulative material.

In use, the heating platform 20 is heated by the heating elements and acts as a primary heat source for cooking. The grill bars 14 which are located a short distance, e.g. 20-70 cm, above the heating platform 20 are heated largely by radiant heat and some convection from the heating platform 20. Thus, the grill bars 14 form a secondary heat source for cooking, but do not contain heating elements themselves. The heating platform 20 is typically heated to a temperature up to about 500° C., at which pyrolytic processes occur, and this enables the grill bars 14 to reach a temperature of 250-350° C. This source of primary heat provided by the heating elements set inside the heating platform 20 remains at a constant temperature, and so any required changes to the secondary heat source for different cooking styles can be achieved through adjustments to the depth between the grill bars 14 and the heating platform 20.

Food items resting on the grill bars 14 are cooked through primarily by heat from the primary heat source, that is the heating platform 20. Direct contact of the food items with the secondary heat source, i.e. the grill bars 14, brands the food items with chargrill lines without completely burning the food items. The temperature which the grill bars 14 attain provides a suitable environment for the Maillard reaction to occur, which gives food its distinctive browned appearance and desirable flavour.

The grill 10 of the present invention does not include a fat tray to collect excess fats and oils. Instead, the grill 10 further comprises a forced air supply system to help the oxidation process of any fat and oils produced by the foodstuffs that would otherwise drip down into the heating chamber 16 during cooking.

When fats and oils combust, the large carbon chain molecules associated with them require more oxygen to achieve complete combustion. With insufficient airflow, a sooty, carbon rich flame with excess carbon monoxide will be produced. However, in the present invention, the forced air supply results in cleaner burning of the fats and oils and a reduction of the black acrid smoke associated with partially burnt oils and fats. It is known that pyrolytic actions commence at around 500° C. and with the addition of oxidation in an aerated environment provided by the forced air supply of the present invention, this can aid in the oxidation of the organic material into an inorganic dust or ash. Therefore, the grill 10 of the present invention ensures complete combustion of any oils and fats, leaving only light ash residue which can be easily vacuumed away during periodic cleaning. The grill 10 does not create fatty residues which present a risk of fire as well as health and environmental concerns.

To provide the forced air supply system in the present invention, the heating chamber 16 is provided within a double-skinned support structure 26 which includes first and second air supplies which supply pressurised air into the heating chamber 16. The support structure 26 comprises inner and outer casings 28,30 nested together with an air chamber 32 between them. This can be seen in FIG. 4. The inner casing 28 has a centrally located opening 36. Below opening 36 there may be an air inlet assembly 34 comprising a perforated wall extending between the inner and outer casings 28,30 defining a central air chamber beneath the opening 36. The structure of the air inlet assembly 34 may be similar to that described in GB2511850. A tube 46 extends upwardly from the opening 36 to the underside of the heating platform 20. The heating platform 20 is also provided with a central opening 38 which is coaxial, but of a smaller diameter, than the tube 46 and the opening 36. These features are best seen in FIG. 5.

Pressurised air is supplied into the chamber 32, for example by fan 44 (which is shown only schematically in FIG. 4, although in practice this may be located within the body 12 of the grill 10, below the support structure 26).

The first (primary) air supply delivers pressurised air into a central region of the heating chamber 16. Pressurised air from the air chamber 32 passes, via the air inlet assembly 34 and the opening 36 into the tube 46 and then through opening 38 in the heating platform 20 into the heating chamber 16.

An air channelling device 40 is located in the opening 38 and protrudes up into the heating chamber 16 and down into the tube 46 towards opening 36. The air channelling device 40 comprises a central column with a plurality of radially projecting ribs. For example, there may be four projecting ribs, so that it is cruciform in cross-section as seen in FIGS. 3 and 5. A circular cap 42 is located on the top end of the air channelling device 40 as seen in FIG. 4. The lower part of the air channelling device 40 can be seen in FIG. 3 while the upper end, without the cap, is illustrated in FIG. 6. The air channelling device 40 divides the opening 38 in the heating platform 20 into four quadrants. The cap 42 deflects upward airflow passing through these four quadrants and diverts it laterally to flow out into the heating chamber 16 across the heating platform 20. This arrangement distributes airflow fairly evenly around the heating chamber 16.

The secondary air supply comprises a plurality of openings 48 in the side walls 22 of the heating chamber 16. Preferably one or more openings 48 are provided in each side wall, located at one end near to a corner where one side wall 22 meets the next. The openings 48 communicate with the air chamber 32 formed in the support structure 26 and therefore jets of pressurised air exit the openings 48 into the heating chamber 16. Since the openings 48 are located towards the corners, this tends to create a vortex airflow which swirls around the heating chamber 16. This helps to pull the airflow from the primary air source in the centre outwardly, to ensure there is good airflow throughout the whole heating chamber 16. In addition, if any fat or oil droplets do combust, the airflow pushes such flare ups laterally rather than upwards. This minimises the flare up and also prevents the food being cooked from becoming burnt.

FIG. 7 is a schematic plan view of the heating platform 20 illustrating the airflow. The arrows P emanating out from the central opening 38 represent the airflow extending out in all directions from the first air supply. The arrows S extending from close to the corners and along the edges represent the airflow from the second air supply which tends to swirl around the heating chamber 16, in this case in an anticlockwise direction. The air flow from central opening 38 initially spreads out radially in all directions across the heating platform 22 but is gradually diverted by the air flow from openings 48 in order to create the vortex of air flowing around the opening 38.

The forced airflow provided by the first and second air supplies permits fuller combustion of any fats and oils from the food items. Any flames which do occur burn more cleanly and quickly and the production of smoke is reduced or eliminated. Any residue will form ash or dust which can be cleared from the heating chamber 16 by vacuuming. No fatty residue or stagnant oil remains to be disposed of.

As noted above, the grill 10 of the present invention does not include a fat tray to collect fats and oils dripping from the food being cooked. Instead, the heating chamber 16 below the grill bars 14 is an enclosed, controlled environment with airflows provided in a controlled manner via the first and second air supplies. Air can only be exhausted from the heating chamber 16 from the top, through the grill bars 14. This contrasts with conventional grills which require fat trays beneath the grill bars and are therefore of a more open construction and subject to external, uncontrolled air movements below the grill bars. In the present invention, the enclosed heating chamber with controlled airflows provides the improved performance of the present invention.

In this way, an improved electric grill is provided. The grill cooks foodstuffs quickly and efficiently, to maintain flavour and texture and with minimal shrinkage. It also obtains the desired chargrill characteristics without burning the food or creating unwanted smoke and fatty residues. The entire heating chamber is heated to a very high temperature which allows the vapourisation of animal fats and oils to occur, minimising residues and keeping the food items succulent.

An alternative embodiment of the electric grill 10 of the present invention is shown in FIG. 8. This differs from the embodiment above in relation to certain features of the secondary air supply into the heating chamber 16, although the other features of the grill 10 are the same as described previously.

In this case, the secondary airflow supplied to the openings 48 in the side walls 22 of the heating chamber 16 is drawn from a second air chamber 50 which is the space between the inner casing 28 and the underside of the heating platform 20. The air in this second air chamber 50 will be heated up when the grill 10 is in use and is drawn via a duct 52 connecting the space 50 to a fan 54. The fan 54 then supplies this heated air into the air chamber 32 between the inner and outer casings 28,30 of the support structure 26. This heated air then flows via the openings 48 into the heating chamber 16 to create the vortex airflow which swirls around the heating chamber 16. The heated air may also be supplied to the air inlet assembly 34 and into the centre of the heating platform 20 in the heating chamber 16. Alternatively, the primary air supply to the air inlet assembly 34 may be ambient air supplied by another fan.

Providing heated air from the second air chamber 50 as the secondary airflow further improves the efficiency of the grill 10. Using air from the second air chamber 50 avoid excessive heat build-up in this part of the grill 10. Furthermore, supplying an already heated airflow into the heating chamber 16 maintains a higher temperature in the corners of the heating chamber 16. This in turn reduces the power requirements of the heating elements in the heating platform 20 so that lower wattage heating elements can be used to maintain an equivalent temperature in the heating chamber 16. Thus, the overall energy input required for the grill 10 is reduced, maximising the efficiency of the product.

1. An electric grill comprising a heating platform, a plurality of side walls, a plurality of grill bars spaced above the heating platform and a heating chamber defined between the heating platform, the side walls and the grill bars, wherein the heating platform is electrically heated, the grill further comprising a first air supply located centrally in the heating platform for delivery of pressurised air into the heating chamber and configured to direct airflow evenly across the heating platform, and a secondary air supply located in the side walls and configured to direct airflow along the side walls to create a vortex of air flowing around the centrally located air supply.

2. An electric grill as claimed in claim 1, wherein the heating platform comprises two conductive plates with electric heating elements sandwiched in between them.

3. An electric grill as claimed in claim 2, wherein the first plate comprises upper and lower surfaces and a plurality of grooves are formed on the lower surface, the second plate comprises upper and lower surfaces and a plurality of grooves are formed in the upper surface, wherein the grooves in the first and second plates co-operate to form channels for receiving heating elements when the first and second plates are sandwiched together.

4. An electric grill as claimed in claim 1, wherein the grill bars do not contain heating elements and are heated by radiation from the heating platform.

5. An electric grill as claimed in claim 4, wherein the heating platform is configured to reach a temperature of up to 500° C. so as to heat the grill bars to a temperature up to 350° C.

6. An electric grill as claimed in claim 1, wherein the heating platform is formed from metal or a ceramic material.

7. An electric grill as claimed as claimed in claim 1, wherein the first air supply comprises at least one opening in the heating platform connected to a source of pressurised air and an airflow diverter configured to divert airflow out across the surface of the heating platform.

8. An electric grill as claimed in claim 7, wherein the airflow diverter comprises an elongate column extending through an opening in the heating platform and a cap mounted on the upper end of the column.

9. An electric grill as claimed in claim 8, wherein the airflow diverter comprises a column with a plurality of radially projecting ribs.

10. An electric grill as claimed in claim 1, wherein the second air supply comprises at least one opening in each side wall located adjacent an end of the side wall and connected to a source of pressurised air.

11. An electric grill as claimed as claimed in claim 1, wherein the heating platform and side walls are located within a housing having inner and outer walls and an air chamber between the inner and outer walls, wherein the air chamber is connected to a source of pressurised air and communicates with the opening in the heating platform and with the openings in the side walls.

12. An electric grill as claimed in claim 10, wherein the source of pressurised air comprises at least one fan.

13. An electric grill as claimed in claim 10, wherein the heating platform and side walls are located within a housing having inner and outer walls and a first air chamber between the inner and outer walls, wherein the air chamber is connected to a source of pressurised air and communicates with the openings in the side walls of the heating chamber, and further comprising a second air chamber defined between the heating platform and the inner wall of the housing, wherein the source of pressurised air comprises a fan configured to draw air from the second air chamber and to supply it to the first air chamber.

14. An electric grill as claimed in claim 1, further comprising a lid which is closeable over the grill bars to provide an enclosed cooking chamber.

15. An electric grill as claimed in claim 11, wherein the source of the pressurised air comprises at least one fan.
